(19) United States
(12) Patent Application Publication
(10) Pub. No.: US 2006/0107206 A1
(43) Pub. Date: May 18, 2006

(54) Form related data reduction

(75) Inventor: Oskari Koskimies, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/988,426

(22) Filed: Nov. 12, 2004

(51) Int. Cl. G06F 17/21; G06F 17/24

(52) U.S. Cl. 715/523; 715/507; 715/513

(57) ABSTRACT

The invention discloses a method, system, server and computer program product of automatically reducing the amount of form related data, e.g. extensible markup language data, sent to a receiving terminal. In the method, a user interface description is analyzed to determine, which parts of the form related data are relevant for the receiving terminal. Based on the analysis, unnecessary parts of the form related data are pruned and the pruned form related data is sent to the receiving terminal. In one embodiment of the invention, XForms is analyzed to determine, which parts of an extensible markup language data are relevant for the receiving terminal.

### BACKGROUND OF THE INVENTION

1. Field of the Invention

The present invention relates to data communications. In particular, the present invention relates to a novel and improved method, system, server and computer program product of automatically reducing the amount of form related data sent to a receiving terminal.

2. Description of the Related Art

XML (Extensible Markup Language) is a flexible way to create common information formats and to share both the format and the data on the World Wide Web, intranets, and elsewhere. XML, a formal recommendation from the World Wide Web Consortium (W3C), is similar to the language of today's Web pages, the Hypertext Markup Language (HTML). Both XML and HTML contain markup symbols to describe the contents of a page or file. HTML, however, describes the content of a Web page (mainly text and graphic images) only in terms of how it is to be displayed and interacted with. For example, the letter “p” placed within markup tags starts a new paragraph. XML describes the content in terms of what data is being described. For example, the word “phonenum” placed within markup tags could indicate that the data that followed was a phone number. This means that an XML file can be processed purely as data by a program or it can be stored with similar data on another computer or, like an HTML file, that it can be displayed. For example, depending on how the application in the receiving computer wanted to handle the phone number, it could be stored, displayed, or dialed.

XML is “extensible” because, unlike HTML, the markup symbols are unlimited and self-defining. XML is actually a simpler and easier-to-use subset of the Standard Generalized Markup Language (SGML), the standard for how to create a document structure. It is expected that HTML and XML will be used together in many Web applications. XML markup, for example, may appear within an HTML page.

Forms are an important part of many Web applications today. HTML forms make it possible for Web applications to interact with their users. Today, ten years after HTML forms became a part of the HTML specification, the Web is a place where millions of users are doing complex transactions that are starting to exceed the limitations of HTML forms. XForms provides a richer, more secure, more reliable, and presentation independent way of handling interactive Web transactions. XForms is the next generation forms markup, which replaces traditional forms in XHTML 2.0 and can just as readily be used with other markups such as Synchronized Multimedia Integration Language (SMIL), used e.g. in Multimedia Messaging (MMS)). XForms use XML for data, making it convenient to use with XML-based information systems. XForms separate the data and logic of a form from its presentation. This way the form data can be defined independent of how the end-user will interact with the application. With XForms, the data displayed in a form and the data submitted from the form, are transported over the Internet using XML. The data content is coded in, and transported as Unicode bytes. Separating data from presentation makes it easier to provide device independent forms, because the data model can be used for all devices. The presentation can be customized for different user interfaces, like mobile phones, handheld devices, and Braille readers for the blind. Since XForms are device independent and based on XML, it is also possible to add XForms elements directly into other XML applications like VoiceXML (speaking web data), WML (Wireless Markup Language), and SVG (Scalable Vector Graphics).

Whereas in HTML form data is contained in the form, in XForms form data is in a separate XML document, to which form controls refer. Since applications nowadays commonly use XML as the data storage format, this allows the form to access application data in its native form without any conversion steps. This allows also several different forms to be used with the same data (=XML document), so that each form provides a different view to the document. For example, there might be a single XML document that describes a client, but the client would access it via a different form (e.g. to maintain his address information) than the sales staff (e.g. to set service priority). Also, a smaller form (leaving out some form fields, focusing on the essential data) could be used for mobile users than for desktop PC users, making the mobile user experience more manageable.

However, this also means that the XML data a form references can frequently be much larger than would be necessary for completing the form, simply because the same data is also used for other purposes (other forms and application internal data). This is not a problem for today's fast Internet connections, but for cellular networks it wastes time, money and terminal storage. It should also be noted that since the XML data must be kept in RAM while processed, the increased storage requirement is valid both for Flash memory and for RAM. In other words, large XML documents (e.g. used for XForms instance data) require a lot of space when stored in a device memory and also plenty of bandwidth is required when they are sent from one device to another. Therefore, large XML documents may not be suitable for mobile environment.

Oracle Corporation, Redwood Shores, California, has presented a prototype offline XForms client for mobile usage, which allows the manual per-application specification of the part of XML data that is actually needed for the application. The client specification can be found e.g. from a web address http://otn.oracle.com/tech/wireless/mobilebrowser/wirelessclientusersguide.pdf. The information is used only on client side to prune away unnecessary parts of the data when loading it into memory. This saves RAM (and possibly increases processing speed) but has no effect on bandwidth or Flash memory usage. Furthermore, the application designer must explicitly specify which parts of the XML data are required. Moreover, the client must support this extension to the standard.

Based on the above, there is an obvious need for a solution that would enable efficient XML data transmission to client, and especially, to mobile clients.

### SUMMARY OF THE INVENTION

By analyzing, for example, an XForms document, it is possible to know exactly which parts of its XML data are actually used. This knowledge can be used to prune away unnecessary parts of the XML data when the XML data is transmitted to the terminal. The pruned parts can be joined back to the document once the terminal submits the modified data. This reduces the consumption of network bandwidth, time, money and terminal storage.

According to one aspect of the invention there is provided a method of automatically reducing the amount of form related data sent to a receiving terminal. The method comprises analyzing a user interface description to determine, which parts of the form related data are relevant for the receiving terminal, pruning, based on the analysis, unnecessary parts of the form related data, and sending the pruned form related data to the receiving terminal.

In one embodiment of the invention, the steps of analyzing and pruning comprises analyzing the user interface description, removing unnecessary parts of the form related data, replacing unnecessary parts of the form related data with at least one reference part, and storing the pruned parts of the form related data in a memory.

In one embodiment of the invention, the step of analyzing comprises determining based on references to form related data in the user interface description, which parts of the form related data are relevant for the receiving terminal. In one embodiment of the invention, the step of analyzing comprises determining, based on XPath expressions in an XForms document, which parts of extensible markup language data are relevant for the receiving terminal.

In one embodiment of the invention, the method further comprising receiving modified pruned form related data from the receiving terminal, and combining the modified pruned form related data with the original form related data. In one embodiment of the invention, the method further comprises receiving modified pruned form related data from the receiving terminal, retrieving the pruned parts of the form related data from a memory, and replacing each reference part in the modified pruned form related data from the receiving terminal with a corresponding part of the form related data in the memory.

In one embodiment of the invention, the form related data and user interface description are in accordance with the XForms specifications.

According to another aspect of the invention there is provided a server for automatically reducing the amount of form related data sent to a receiving terminal. The server comprises an analyzing unit configured to analyze a user interface description, to determine which parts of the form related data are relevant for the receiving terminal, a modifying unit configured to prune, based on the analysis, unnecessary parts of the form related data, and a transmitter configured to send the pruned form related data to the receiving terminal.

In one embodiment of the invention, the analyzing unit is configured to analyze the user interface description, the modifying unit is configured to remove unnecessary parts of the form related data and to replace unnecessary parts of the form related data with at least one reference part, and wherein the server further comprises a memory configured to store the pruned parts of the form related data.

In one embodiment of the invention, the analyzing unit is configured to determine, based on references to form related data in the user interface description, which parts of the form related data are relevant for the receiving terminal. In one embodiment of the invention, the analyzing unit is configured to determine, based on XPath expressions in an XForms document, which parts of extensible markup language data are relevant for the receiving terminal.

In one embodiment of the invention, the server further comprises a receiver configured to receive modified pruned form related data from the receiving terminal, and a combining unit configured to combine the modified pruned form related data with the original form related data. In one embodiment of the invention, the modifying unit is configured to retrieve the pruned parts of the form related data from a memory and to replace each reference part in the modified pruned form related data from the receiving terminal with a corresponding part of the form related data in the memory.

In one embodiment of the invention, the form related data and user interface description are in accordance with the XForms specifications.

According to another aspect of the invention there is provided a computer program product automatically reducing the amount of form related data sent to a receiving terminal, comprising code stored on at least one data-processing device readable medium, the code adapted to perform the following steps when executed on a data-processing device: analyzing a user interface description to determine, which parts of the form related data are relevant for the receiving terminal, pruning, based on the analysis, unnecessary parts of the form related data, and sending the pruned form related data to the receiving terminal.

In one embodiment of the invention, the computer program product is further adapted to perform the following steps when executed on said data-processing device: analyzing the user interface description, removing unnecessary parts of the form related data, replacing unnecessary parts of the form related data with at least one reference part, and storing the pruned parts of the form related data in a memory.

In one embodiment of the invention, the computer program product is further adapted to perform the following step when executed on said data-processing device: determining based on references to form related data in the user interface description, which parts of the form related data are relevant for the receiving terminal. In one embodiment of the invention, the computer program product is further adapted to perform the following step when executed on said data-processing device: determining, based on XPath expressions in an XForms document, which parts of extensible markup language data are relevant for the receiving terminal.

In one embodiment of the invention, the computer program product is further adapted to perform the following steps when executed on said data-processing device: receiving modified pruned form related data from the receiving terminal, and combining the modified pruned form related data with the original form related data. In one embodiment of the invention, the computer program product is further adapted to perform the following steps when executed on said data-processing device: receiving modified pruned form related data from the receiving terminal, retrieving the pruned parts of the form related data from the memory, and replacing each reference part in the modified pruned form related data from the receiving terminal with a corresponding part of the form related data in the memory.

In one embodiment of the invention, the form related data and user interface description are in accordance with the XForms specifications.

According to another aspect of the invention there is provided a system of automatically reducing the amount of form related data sent to a receiving terminal. The system comprises a receiving terminal and a server comprising an analyzing unit configured to analyze a user interface description, to determine which parts of the form related data are relevant for the receiving terminal, a modifying unit configured to prune, based on the analysis, unnecessary parts of the form related data and a transmitter configured to send the pruned form related data to the receiving terminal.

In one embodiment of the invention, the analyzing unit is configured to analyze the user interface description, the modifying unit is configured to remove unnecessary parts of the form related data and to replace unnecessary parts of the form related data with at least one reference part, and wherein the server further comprises a memory configured to store the pruned parts of the form related data.

In one embodiment of the invention, the analyzing unit is configured to determine, based on references to form related data in the user interface description, which parts of the form related data are relevant for the receiving terminal. In one embodiment of the invention, the analyzing unit is configured to determine, based on XPath expressions in an XForms document, which parts of extensible markup language data are relevant for the receiving terminal.

In one embodiment of the invention, the server further comprises a receiver configured to receive modified pruned form related data from the receiving terminal and a combining unit configured to combine the modified pruned form related data with the original form related data.

In one embodiment of the invention, the modifying unit is configured to retrieve the pruned parts of the form related data from a memory and to replace each reference part in the modified pruned form related data from the receiving terminal with a corresponding part of the form related data in the memory.

In one embodiment of the invention, the form related data and user interface description are in accordance with the XForms specifications.

The present invention has advantages over the prior-art solutions. The amount of data sent from server to client is reduced. This reduces time and cost of data transfer, as well as storage requirements on terminal. Processing speed in general might also increase, as there is less data to handle, especially in conjunction with offline usage, where data is loaded and saved locally. With offline usage the reduced storage requirements are also more important, as the user may have a multitude of forms (and related XML data) stored on his terminal for offline use.

The invention may also be implemented purely on server side so that it is compatible with standard XForms clients.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIGS. 1a, 1b, 2, 3a and 3b illustrate one embodiment of the method according to the invention,

FIG. 4a is a block diagram illustrating one embodiment of a proxy server according to the invention;

FIG. 4b is a block diagram illustrating one embodiment of the system according to the invention; and

FIG. 4c is a block diagram illustrating another embodiment of the system according to the invention.

### DETAILED DESCRIPTION OF THE PREFERRED EMBODIMENTS

Reference will now be made in detail to the embodiments of the present invention, examples of which are illustrated in the accompanying drawings.

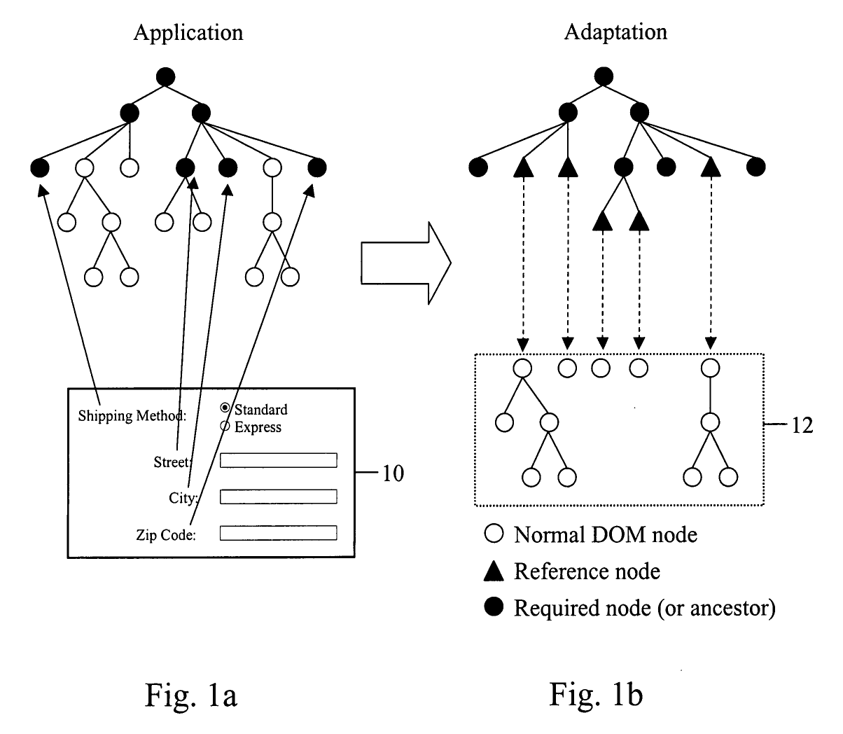

FIGS. 1a, 1b, 2, 3a and 3b illustrate one embodiment of the method in accordance with the invention.

FIG. 1a discloses a tree view of form related data within an application. In one embodiment, the form related data refers to extensible markup language data (XML), the tree view refers to a document object model (DOM) tree view and the user interface description refers to an XForms document. In general, the term form related data is used to describe the data structure stored in a memory or file system, wherein the data structure is binary or textual format, hierarchical or tree like in nature and related to a form or user interface description. Therefore, the form related data may refer to any other appropriate data other than the extensible markup language data.

Filled circles represent nodes or ancestors that are required in a remaining pruned tree. Hollow circles represent nodes that are normal document object model nodes that can be pruned from tree before sending extensible markup language data to a receiving terminal. A form 10 comprises four different form controls (inputs) that map to four different nodes in the tree.

FIG. 1b discloses a document object model tree view of pruned extensible markup language data after adaptation. In the adaptation process nodes that are not required nodes are pruned out from the tree (hollow circles in a box 12). The nodes that are pruned may be stored in a memory for later retrieval. Once the required XML data document object model nodes have been marked, all their ancestors (parents, parents' parents, and so on) must be marked as well. Otherwise, the result would not be itself a document object model tree. Once that is done, all the unmarked direct children (hollow circles) of the marked nodes represent unnecessary sub-trees, which can safely be pruned and replaced with a reference node (a triangle) . The reference node points to the sub-tree so that it can later be joined back to the pruned tree to make it complete once again. In one embodiment, the reference may be a Uniform Resource Locator (URL), pointing to the server doing the pruning, so that if a client for some reason would still require a pruned part, it may request it from the URL.

In an XForms document, each form control specifies which part or parts of the XML data it requires (using e.g. XPath statements). This may be specified directly in the form control using a ref attribute, or it may be specified in a separate bind element to which the form control refers using a bind attribute. By evaluating the XPath statements that define what data is required, it is possible to mark in the XML data document object model those nodes that are required by the form. Other things in an XForms document that refer to the XML data are handled similarly, such as other binding attributes (e.g. relevant, read-only), actions or repeat elements. In short, every XPath statement in the XForms document is analyzed and the document object model node(s) they refer to are marked. Since XForms is declarative in nature, it is possible to do this both efficiently and correctly.

It is important to note that the pruning process can be transparent to the application.

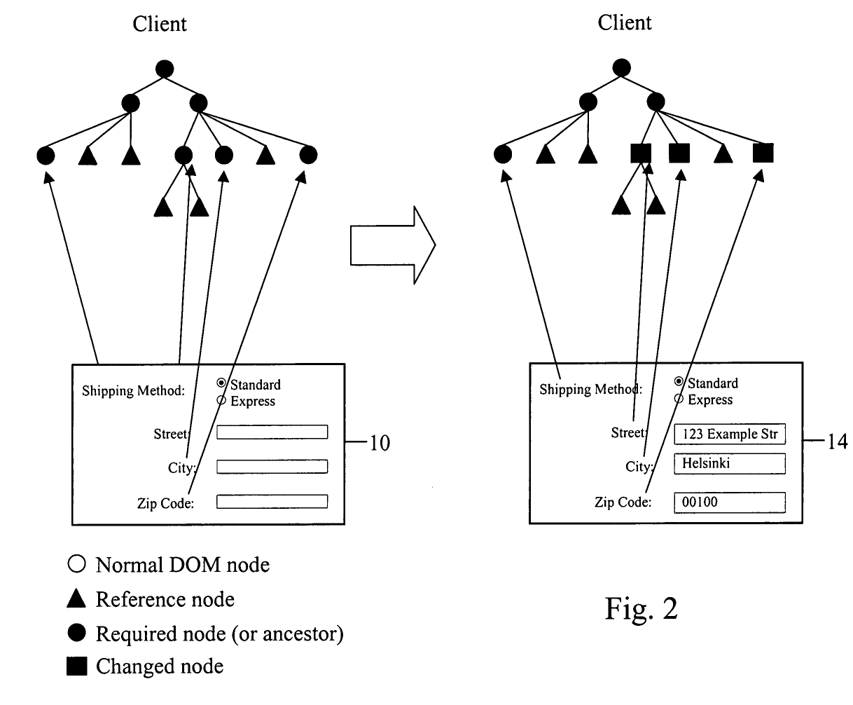

FIG. 2 illustrates the situation when a client receives the pruned XML data. The client operates on it normally as all the nodes it references are exactly the same as in the original XML data. The user fills in the form 14. This modifies the XML data (black squares). The modified pruned XML data is sent back to the adaptation process.

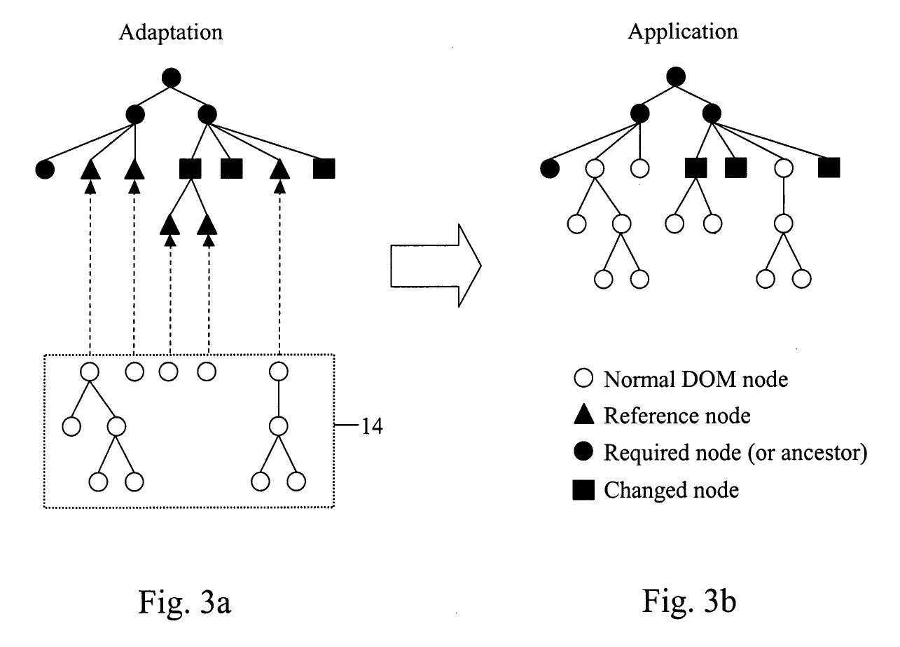

FIG. 3a discloses the situation when the adaptation process receives the modified pruned XML data. The adaptation process matches each reference node (triangles) to a sub-tree pruned earlier. The sub-trees were earlier stored in a memory where they can be retrieved. The adaptation process replaces the reference nodes with corresponding sub-trees. As a result, an XML data document object model tree with the same structure as the original is obtained, which also contains the user input data.

In FIG. 3b the application has received the XML data object model tree comprising the user data. The tree is now ready for processing by the application, which can, for example, validate it by using an original Schema.

If synchronization is used, then the adaptation process part shown in FIGS. 1b and 3a may be integrated to the synchronization service. As the synchronization service needs to maintain the original version of the XML data anyway in order to be able to later resolve possible conflicts, there is no need to store the pruned sub-trees. Rather the references can point to sub-trees in the original document object model tree. With synchronization it may also be possible to leave out the last step of rebuilding the full document object model tree, and instead synchronize the pruned document object model tree directly with the original tree. In order to do this, however, the synchronization algorithm needs to be aware that the reference nodes correspond to unchanged sub-trees.

If it is possible for the same user to have multiple XForms documents referring to the same XML data in an offline mode, then the system may consider all referring XForms documents (that are present at the terminal) when determining the required subset of the XML data. Using a separate copy of the XML data for each XForms document is not acceptable, both because it would increase probability of conflicts, and because the user would expect changes in one form to be reflected in the other, if both forms access the same data. The offline system therefore needs to track which XML data is referenced by each form, so that it can determine the required subset of data that is needed.

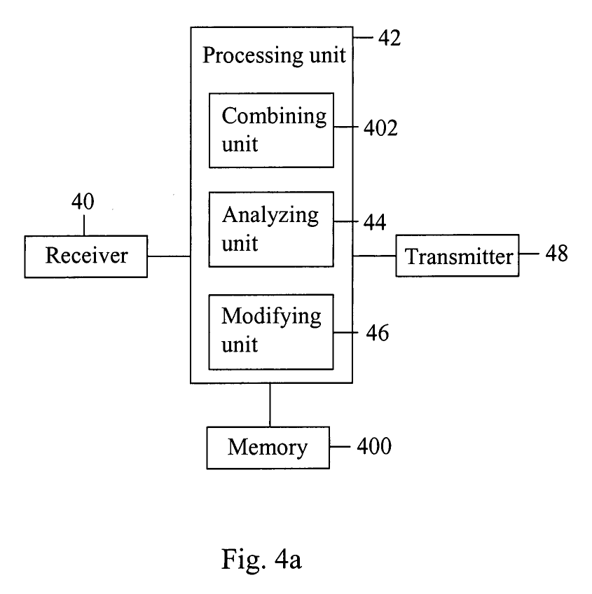

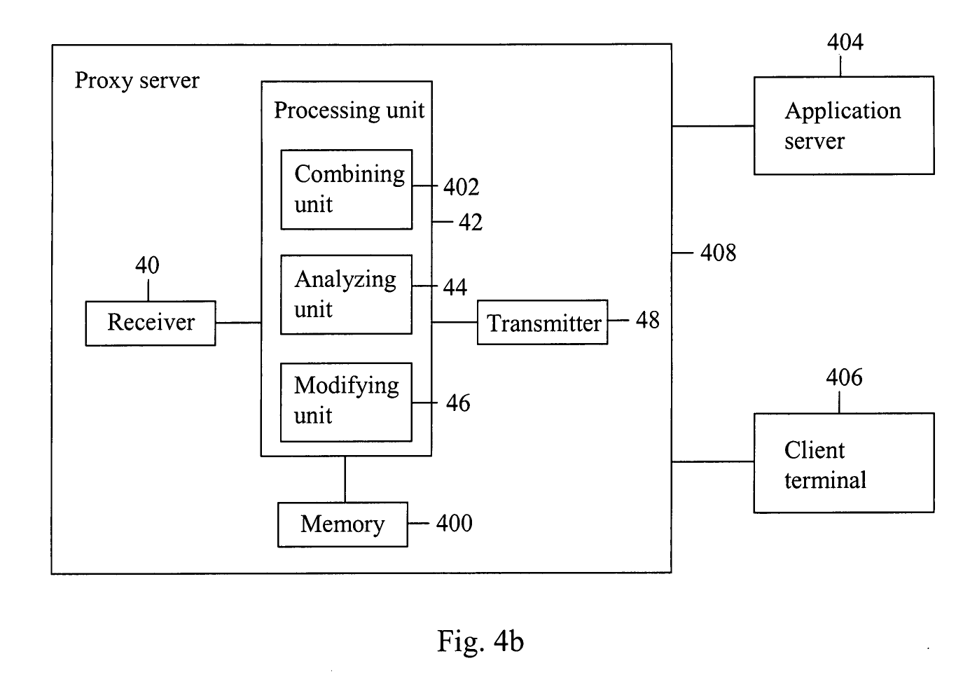

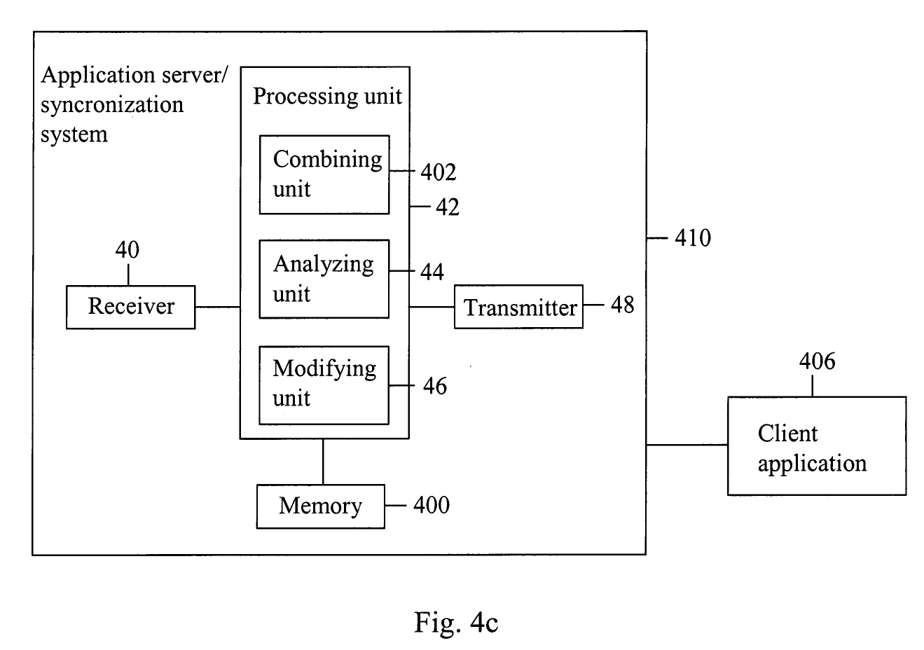

FIG. 4a discloses one embodiment of a proxy server according to the invention. A transmitter 48 is configured to send the pruned extensible markup language data to the receiving terminal. The transmitter 48 is also configured to send the combined extensible markup language data to the application. A receiver 40 is also configured to receive modified pruned extensible markup language data from a receiving terminal.

The server further comprises a processing unit 42 that comprises an analyzing unit 44 configured to analyze a user interface description, to determine which parts of the extensible markup language data are relevant for the receiving terminal, and a modifying unit 46 configured to prune, based on the analysis, unnecessary parts of the extensible markup language data. The analyzing unit 44 may also be configured to analyze the user interface description, e.g. the form controls (and other elements containing XPath expressions that refer to the extensible markup language data) of an XForms document, to determine which parts of the extensible markup language data are relevant for a receiving terminal. The modifying unit 46 may also be configured to remove unnecessary child nodes of the extensible markup language data and to replace an unnecessary sub-tree of at least one child node with a reference node. Furthermore, the modifying unit 46 may also be configured to retrieve the pruned parts of the extensible markup language data from a memory 400 and to replace each reference node in the modified pruned extensible markup language data from the receiving terminal with a corresponding sub-tree. A combining unit 402 is configured to combine the modified pruned extensible markup language data with the original extensible markup language data. In one embodiment of FIG. 4a, the extensible markup language data and the user interface description are in accordance with the XForms specifications.

FIG. 4a illustrates a single memory 400. The memory 400 may refer to a single memory or memory area or to a plurality of memories or memory areas that may include e.g. random access memories (RAM), read-only memories (ROM) etc. The memory 400 may also include other applications or software components that are not described in more detail and also may include the computer program (or portion thereof), which when executed on a processing unit 42 performs at least some of the steps of the invention. The processing unit 42 may also include memory or a memory may be associated therewith which may include the computer program (or portion thereof) which when executed on processing unit 42 performs at least some of the steps of the invention.

FIG. 4b discloses one embodiment of a system according to the invention. The system comprises a proxy server 408 disclosed in FIG. 4a. The proxy server has a connection to an application server 404 and to a client terminal 406. The client terminal 406 is e.g. a mobile terminal, mobile phone, a personal digital assistant, a computer or any other appropriate terminal.

FIG. 4c discloses another embodiment of a system according to the invention. In FIG. 4c the proxy server in FIG. 4a is integrated to an application server/synchronization system 410. Based on the above, the invention can be integrated to an application server or to a synchronization system, or it can be deployed as a transparent proxy in front of a web application. The two first approaches are probably more efficient, but the proxy approach may be suitable as an addition to existing adaptation proxy systems.

It is obvious to a person skilled in the art that with the advancement of technology, the basic idea of the invention may be implemented in various ways. The invention and its embodiments are thus not limited to the examples described above, instead they may vary within the scope of the claims.

What is claimed is:

1. A method of automatically reducing the amount of form related data sent to a receiving terminal, the method comprising:
analyzing a user interface description to determine, which parts of the form related data are relevant for the receiving terminal;
pruning; based on the analysis, unnecessary parts of the form related data; and
sending the pruned form related data to the receiving terminal.

2. The method according to claim 1, wherein the steps of analyzing and pruning comprises:
analyzing the user interface description;
removing unnecessary parts of the form related data;
replacing unnecessary parts of the form related data with at least one reference part; and
storing the pruned parts of the form related data in a memory.

3. The method according to claim 1, wherein the step of analyzing comprises:
determining based on references to form related data in the user interface description, which parts of the form related data are relevant for the receiving terminal.

4. The method according to claim 3, wherein the step of analyzing comprises:
determining, based on XPath expressions in an XForms document, which parts of extensible markup language data are relevant for the receiving terminal.

5. The method according to claim 1, further comprising:
receiving modified pruned form related data from the receiving terminal; and
combining the modified pruned form related data with the original form related data.

6. The method according to claim 5, further comprising:
receiving modified pruned form related data from the receiving terminal;
retrieving the pruned parts of the form related data from a memory; and
replacing each reference part in the modified pruned form related data from the receiving terminal with a corresponding part of the form related data in the memory.

7. The method according to claim 1, wherein the form related data and the user interface description are in accordance with the XForms specifications.

8. A server for automatically reducing the amount of form related data sent to a receiving terminal, comprising:
an analyzing unit configured to analyze a user interface description, to determine which parts of the form related data are relevant for the receiving terminal;
a modifying unit configured to prune, based on the analysis, unnecessary parts of the form related data; and
a transmitter configured to send the pruned form related data to the receiving terminal.

9. The server according to claim 8, wherein:
the analyzing unit is configured to analyze the user interface description;
the modifying unit is configured to remove unnecessary parts of the form related data and to replace unnecessary parts of the form related data with at least one reference part; and
wherein the server further comprises a memory configured to store the pruned parts of the form related data.

10. The server according to claim 8, wherein:
the analyzing unit is configured to determine, based on references to form related data in the user interface description, which parts of the form related data are relevant for the receiving terminal.

11. The server according to claim 10, wherein:
the analyzing unit is configured to determine, based on XPath expressions in an XForms document, which parts of extensible markup language data are relevant for the receiving terminal.

12. The server according to claim 8, further comprising:
a receiver configured to receive modified pruned form related data from the receiving terminal; and
a combining unit configured to combine the modified pruned form related data with the original form related data.

13. The server according to claim 12, wherein:
the modifying unit is configured to retrieve the pruned parts of the form related data from a memory and to replace each reference part in the modified pruned form related data from the receiving terminal with a corresponding part of the form related data in the memory.

14. The server according to claim 8, wherein the form related data and the user interface description are in accordance with the XForms specifications.

15. A computer program product automatically reducing the amount of form related data sent to a receiving terminal, comprising code stored on at least one data-processing device readable medium, the code adapted to perform the following steps when executed on a data-processing device:
analyzing a user interface description to determine, which parts of the form related data are relevant for the receiving terminal;
pruning, based on the analysis, unnecessary parts of the form related data; and
sending the pruned form related data to the receiving terminal.

16. The computer program product according to claim 15, further adapted to perform the following steps when executed on said data-processing device:
analyzing the user interface description;
removing unnecessary parts of the form related data;
replacing unnecessary parts of the form related data with at least one reference part; and
storing the pruned parts of the form related data in a memory.

17. The computer program product according to claim 15, further adapted to perform the following step when executed on said data-processing device:
determining, based on references to form related data in the user interface description, which parts of the form related data are relevant for the receiving terminal.

18. The computer program product according to claim 17, further adapted to perform the following step when executed on said data-processing device:
determining, based on XPath expressions in an XForms document, which parts of extensible markup language data are relevant for the receiving terminal.

19. The computer program product according to claim 15, further adapted to perform the following steps when executed on said data-processing device:
receiving modified pruned form related data from the receiving terminal; and
combining the modified pruned form related data with the original form related data.

20. The computer program product according to claim 19, further adapted to perform the following steps when executed on said data-processing device:
receiving modified pruned form related data from the receiving terminal;
retrieving the pruned parts of the form related data from the memory; and
replacing each reference part in the modified pruned form related data from the receiving terminal with a corresponding part of the form related data in the memory.

21. The computer program product according to claim 15, wherein the form related data and the user interface description are in accordance with the XForms specifications.

22. A system of automatically reducing the amount of form related data sent to a receiving terminal, comprising:
a receiving terminal; and
a server comprising an analyzing unit configured to analyze from a user interface description, which parts of the form related data are relevant for the receiving terminal, a modifying unit configured to prune, based on the analysis, unnecessary parts of the form related data and a transmitter configured to send the pruned form related data to the receiving terminal.

23. The system according to claim 22, wherein:
the analyzing unit is configured to analyze the user interface description;
the modifying unit is configured to remove unnecessary parts of the form related data and to replace unnecessary parts of the form related data with at least one reference part; and
wherein the server further comprises a memory configured to store the pruned parts of the form related data.

24. The system according to claim 22, wherein:
the analyzing unit is configured to determine, based on references to form related data in the user interface description, which parts of the form related data are relevant for the receiving terminal.

25. The system according to claim 24, wherein:
the analyzing unit is configured to determine, based on XPath expressions in an XForms document, which parts of extensible markup language data are relevant for the receiving terminal.

26. The system according to claim 22, wherein the server further comprises:
a receiver configured to receive modified pruned form related data from the receiving terminal; and
a combining unit configured to combine the modified pruned form related data with the original form related data.

27. The system according to claim 22, wherein:
the modifying unit is configured to retrieve the pruned parts of the form related data from a memory and to replace each reference part in the modified pruned form related data from the receiving terminal with a corresponding part of the form related data in the memory.

28. The system according to claim 22, wherein the form related data and the user interface description are in accordance with the XForms specifications.
